(19) United States
(12) Patent Application Publication
(10) Pub. No.: US 2003/0095503 A1
(43) Pub. Date: May 22, 2003

(54) Traffic control apparatus and method for UBR service in ATM exchanges

(75) Inventor: Sung Woo Ha, Scongnam-si (KR)

Correspondence Address: FLESHNER & KIM, LLP, P.O. BOX 221200, CHANTILLY, VA, 20153, US

(73) Assignee: LG Electronics Inc.

(21) Appl. No.: 10/289,371

(22) Filed: Nov. 7, 2002

(30) Foreign Application Priority Data
Nov. 16, 2001 (KR) 71464/2001

(51) Int. Cl. H04L 12/26

(52) U.S. Cl. 370/232

(57) ABSTRACT

A traffic control apparatus for UBR service includes a first subscriber side connected to a second subscriber side through an ATM exchange. The first subscriber side includes an egress subscriber end which extracts UBR band information of the subscriber board of a second subscriber end fed back, and which determines the UBR band in accordance with the presence of cell traffic congestion and traffic loading state transmitted from the board of the second subscriber end. The apparatus further includes an ingress subscriber end which receives the UBR band information determined by the egress subscriber end, feeds back the UBR band information to the subscriber board of the second subscriber end, and processes a UBR user cell in accordance with the UBR band information of the second subscriber's board. The apparatus is advantageous in that it secures the quality of service of real-time traffic and utilizes any available real-time traffic band for UBR traffic, thereby preventing waste of bands and controlling UBR traffic more effectively.

### BACKGROUND OF THE INVENTION

1. Field of the Invention

The present invention relates to a method and apparatus for controlling traffic for an unspecified bit rate (UBR) service in an asynchronous transfer mode (AMT) exchange.

2. Background of the Related Art

In general, the ATM switch that links a user cell from an ingress subscriber end to an egress subscriber end in the ATM exchange is required to meet corresponding quality of service (QoS) associated with a variety of traffics, such as, voice, data, video signal and so forth.

ATM services are largely divided into three kinds. The first is a constant bit rate (CBR), non real-time variable bit rate (nrt-VBR), and real-time variable bit rate (rt-VBR) service which guarantees the quality of service in a call set-up step. The second is an available bit rate (ABR) service, which transmits data using available bandwidths of remaining links that are not used in the ATM service. And, the third is an unspecified bit rate (UBR) service, which does not guarantee service performance over the network.

The ABR and the UBR services are seriously being considered to accommodate Internet service based on an ATM communication network, since Internet service is in great need recently and it is expected to occupy more than 90% of traffic in the near future.

Unlike the CBR or VBR service which uses a fixed bandwidth assigned during a connection setup time, the ABR service uses bandwidth that is dynamically assigned depending on a situation over the ATM network through flow control between a transceiver and the network. Therefore, ABR service is generally used in a service that is relatively insensitive to cell delay and sensitive to cell loss.

UBR service is only used when extra bandwidth exists within the network. As a result, nothing in terms of the quality of service can be guaranteed. It is therefore based on the best-effort concept just like Internet service.

FIG. 1 diagrammatically shows a UBR traffic control apparatus implemented in an ATM exchange of the related art. The apparatus includes a subscriber board including ingress subscriber ends 100A and 100B, egress subscriber ends 300A and 300B, and an ATM switch 200. The ingress subscriber ends 100A and 100B receive user cells from a universal test and operation physical interface for ATM (UTOPIA). The user cells are then transmitted to an input port of the ATM switch 200. The ATM switch 200 links user cells that have been input into a plurality of input ports with an output port. The cells are then transmitted to the UTOPIA through egress subscriber ends 300A and 300B.

Operation of the UBR traffic control apparatus is as follows. Since UBR traffic does not assign a bandwidth at the time of connection setup due to class characteristics, traffic congestion may happen anytime at an output port of the ATM switch 200. In such a case, egress subscriber ends 300A and 300B feedback information about available bandwidth (ΔBW) of the UBR connection periodically to every UBR buffer in the ingress subscriber ends 100A and 100B through control cells having a predetermined format in the inside of the ATM exchange. The ingress subscriber ends 100A and 100B process the UBR user cells in accordance with the fedback information about the UBR available bandwidth, in order to prevent the traffic congestion of the UBR cell.

To satisfy the quality of service for real time traffic at the time of UBR connection or release, the UBR available bandwidth is determined by using the following mathematical Equation 1

ΔBW=[ρ*c−(Σ(PCRᵢ)+Σ(SCRⱼ))]/k (1)

wherein, ρ is a target link utilization; ‘c’ is a link capacity, ‘PCRᵢ’ is a peak cell rate in the constant bit rate (CBR) connection; ‘SCRⱼ’ is a sustainable cell rate in the variable bit rate (VBR) connection; and ‘k’ is a number of UBR connection. The thusly determined UBR available bandwidth (ΔBW) is set up as the UBR band for every UBR connection, and is fedback to the ingress subscriber ends 100A and 100B through the control cells.

Depending on the fedback UBR available band information of the control cell, the ingress subscriber ends 100A and 100B extract the UBR user cells stored in a UBR buffer, and transmit the user cell to the ATM switch 200. At this time, the ingress subscriber ends 100A and 100B decide whether or not the UBR user cells stored in the UBR buffer exceed a threshold of the UBR buffer.

If it turns out that the UBR user cells exceed the threshold of the UBR buffer, the ingress subscriber ends 100A and 100B discard the UBR user cells using either an early packet discarding (EPD) method or a partial packet discarding (PPD) method. However, if the UBR user cells do not exceed the threshold, the ingress subscriber ends 100A and 100B extract the UBR user cells and transmit the cells to ATM switch 200.

As previously noted, similar to real-time traffic, the available band of the UBR connection is set up for the UBR traffic, and any input UBR user cell exceeding the predetermined band is either stored in the UBR buffer of the ingress subscriber end or discarded. That is to say, any UBR user cell greater than the predetermined band cannot be input into the ATM switch, so the traffic congestion that often occurs in the output port of the ATM switch can be prevented.

In spite of these advantages, the traffic control method of the related art has a number of drawbacks. Perhaps most significantly, this method wastes bandwidth and lowers UBR traffic efficiency because the band (ΔBW) determined at the time of UBR connection or release is fixed as the UBR available band for the UBR connection. Consequently, even when there is no need to use a reserved band in the real-time traffic, the UBR traffic cannot use the available band at all.

### SUMMARY OF THE INVENTION

An object of the invention is to solve at least the above problems and/or disadvantages and to provide at least the advantages described hereinafter.

It is an object of the present invention to provide a traffic control apparatus and traffic control method for unspecified bit rate (UBR) service in an asynchronous transfer mode (AMT) exchange, capable of guaranteeing the quality of service of real time traffic and controlling UBR traffic more effectively by preventing waste of bands.

These and other objects and advantages of the invention are achieved by providing a traffic control apparatus for UBR service in an ATM exchange, the apparatus including an egress subscriber end at a first subscriber end which extracts UBR band information of a first subscriber board, and determines the UBR band in accordance with a presence of cell traffic congestion and a state of traffic loading transmitted from the first subscriber board. The apparatus also includes an ingress subscriber end which receives the UBR band information determined by the egress subscriber end, gives feedback to the first subscriber board, and processes a UBR user cell in accordance with the UBR band information of the first subscriber board extracted from the egress subscriber end.

The egress subscriber end includes a load measuring unit for measuring traffic load of a transmitted cell from the ATM switch and for outputting a traffic load signal; a user cell extracting unit for extracting at least an user cell among outputted cells from the ATM switch; an egress buffer unit for outputting a traffic congestion state signal based on a decision that is periodically made on traffic situations of UBR user cells stored in an internal UBR buffer among user cells extracted by the user cell extracting unit; a traffic situation decision unit for deciding a UBR band corresponding to the traffic congestion state signal outputted from the egress buffer and the traffic load signal outputted from the load measuring unit, and outputting information on the determined UBR band; a control cell generating unit for loading the information on the UBR band outputted from the traffic situation decision unit onto a control cell, and for transmitting the information to an ingress subscriber end inside of a second subscriber board ; and a control cell information extracting unit for extracting the information on the UBR band of the first subscriber board from the control cell that is transmitted from the load measuring unit, and for transmitting the information to the ingress subscriber end inside of the second subscriber board.

The ingress subscriber end includes: a buffer managing unit for processing user cells transmitted from an universal test and operation physical interface for ATM (UTOPIA) in accordance with priority; a UBR buffer for storing the UBR user cell among other user cells inputted in the buffer managing unit; a first-in first-out (FIFO) for extracting the information on the UBR band from the control cell transmitted from the control cell generating unit of the egress subscriber end, and for transmitting the information together with the user cell to an ATM switch; and a scheduler for deciding an extract time of the UBR user cell in accordance with the information on the UBR band of a first subscriber board transmitted from the control cell information extracting unit of the egress subscriber end, and for transmitting the UBR managing information including the decided extract time to the buffer managing unit. The UBR buffer may store the inputted UBR user cell by connections.

Another embodiment of the present invention provides a traffic control method for UBR service in an ATM exchange mounted with an ATM switch for processing user cells. The method includes receiving cell information from the first subscriber board; extracting UBR user cells out of the received cell information and storing the UBR user cell in a buffer; determining a UBR band by deciding whether or not the stored UBR user cell exceeds the threshold of the buffer; and extracting the UBR user cell out of the user cells transmitted from the UTOPIA and transmitting the UBR user cell together with the determined UBR band information to the first subscriber board.

Another embodiment of the present invention provides a traffic control method for UBR service in an ATM exchange mounted with an ATM switch for processing user cells, the method including the steps of receiving cell information from an ingress subscriber end of a first subscriber board; extracting a UBR user cell out of the received cell information and storing the UBR user cell in a buffer; deciding whether or not the stored UBR user cells exceed a threshold of the buffer; decreasing a current UBR band, if the UBR user cell exceeds a threshold of a corresponding buffer; determining a UBR band by comparing the decreasing UBR band with a UBR available band; and transmitting the determined UBR band information to the first subscriber board through an ingress subscriber board of a second subscriber board and an ATM exchange.

Preferably, the cell information is either user cell or control cell, and the threshold of the buffer, given that the cell traffic is in a normal state, is a maximum value of the UBR user cells stored in the UBR buffer. If the UBR user cell is not greater than the threshold of a corresponding buffer, it is decided whether traffic load is not larger than the predetermined load standard value. If it turns out that the traffic load is lower than the predetermined load standard value, the current UBR band is increased, and the increased UBR band information is then transmitted to the egress subscriber end of the first subscriber board through the ingress subscriber end of the second subscriber board and the ATM switch.

Normally, the load standard value is obtained through a calculation of target link utilization and link capacity. On the other hand, if the traffic load is greater than the predetermined load standard value, the current UBR band is kept. Increasing the current UBR band is accomplished through a mathematics, that is, Current UBR band+{(Load standard value−Current UBR band)/Constant}. Moreover, the UBR band is determined based on the comparison of the decreased UBR band with a UBR available band. That is, if the decreased UBR band is less than the UBR available band, the UBR available band becomes the UBR band. Meanwhile, if the decreased UBR band is greater than the UBR available band, the decreased UBR band becomes the UBR band.

Another embodiment of the present invention corresponds to a traffic control method for UBR service in an ATM exchange mounted with an ATM switch for processing user cells, the method including the steps of receiving user cells from a UTOPIA and storing them by connections; extracting UBR user cells corresponding to UBR managing information out of the stored user cells; and transmitting the extracted UBR user cells together with control cells transmitted from an egress subscriber end of one subscriber board to an egress subscriber end of another subscriber board.

The UBR managing information indicates the extract time of the determined UBR user cells using the UBR band information transmitted from the egress subscriber end of the one subscriber board, and the control cell includes the determined UBR band information corresponding to a traffic congestion state signal or traffic load signal from the egress subscriber end of the one subscriber board.

Another embodiment of the present invention corresponds to a traffic control method for UBR service in an ATM exchange to measure traffic load at a load measuring unit of an egress subscriber end having a shift register, the method comprising the steps of setting a value for a counter to be correspondent to presence of cell flow during a first cell time, and shifting the counter by one space during a second cell time, and repeating the value setup process for the counter corresponding to the presence of cell flow; calculating a cell count value of the counter in a specific cycle; and obtaining a load using the calculated count value. The step of obtaining the load is accomplished by a calculation of a maximum speed of cell traffic, the calculated count value, and the counter register.

Another embodiment of the present invention corresponds to a traffic control method for UBR service in an ATM exchange to determine the UBR band by a traffic situation decision unit, the method comprising the steps of setting an initial UBR band as a full band value; deciding whether a traffic congestion generating signal is received or not; decreasing a current UBR band, if the traffic congestion generating signal is received, and determining a UBR band by comparing the decreased UBR band with a UBR available band.

In summary, according to the present invention, the UBR band is dynamically determined in accordance with the cell traffic congestion state in the egress subscriber end or traffic load, and the determined band information is loaded onto the control cell and is fed back to the ingress subscriber end, where the UBR user cell is processed in accordance with the fed back UBR band information. In this manner, the traffic control apparatus and traffic control method for UBR service in ATM exchange of the present invention can assure the quality of service of real time traffic, prevent any waste of a band, and control UBR traffic more effectively by utilizing an available real time traffic band for the UBR traffic as much as possible.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram of a related traffic control apparatus for unspecified bit rate (UBR) service in an asynchronous transfer mode (ATM) exchange;

FIGS. 2a and 2b are block diagrams illustrating a traffic control apparatus for UBR service in ATM exchanges in accordance with a preferred embodiment of the present invention;

FIG. 3 is a flow chart illustrating a UBR traffic control method at an ingress subscriber end in accordance with the preferred embodiment of the present invention;

FIG. 4 is a flow chart illustrating a UBR traffic control method at an exist subscriber end in accordance with the preferred embodiment of the present invention;

FIG. 5 is a flow chart illustrating a method for measuring traffic load of a UBR user cell in accordance with the preferred embodiment of the present invention; and

FIG. 6 is a flow chart illustrating a method for determining a UBR band in accordance with the preferred embodiment of the present invention.

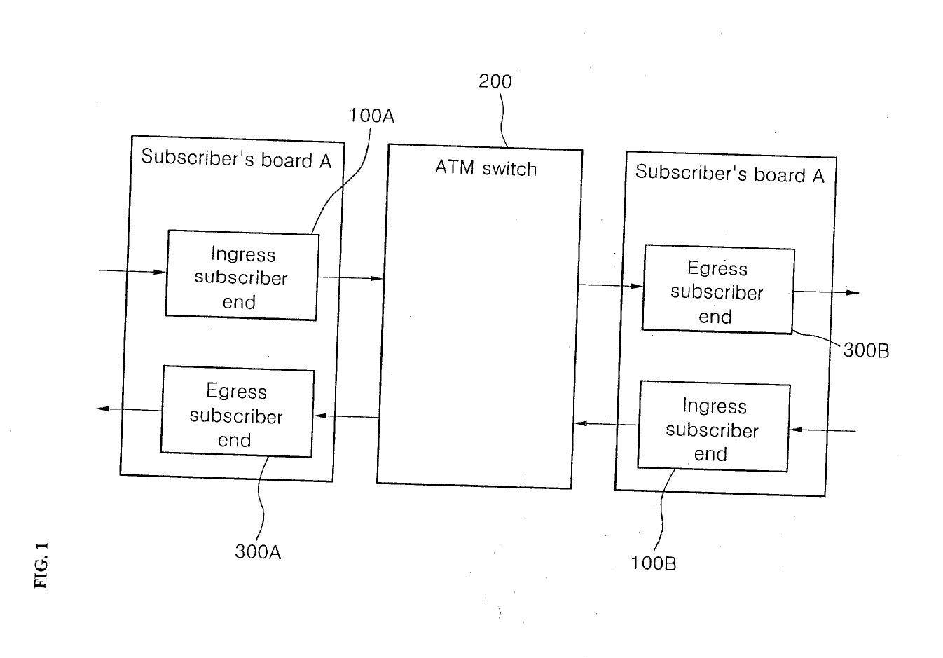

### DETAILED DESCRIPTION OF PREFERRED EMBODIMENTS

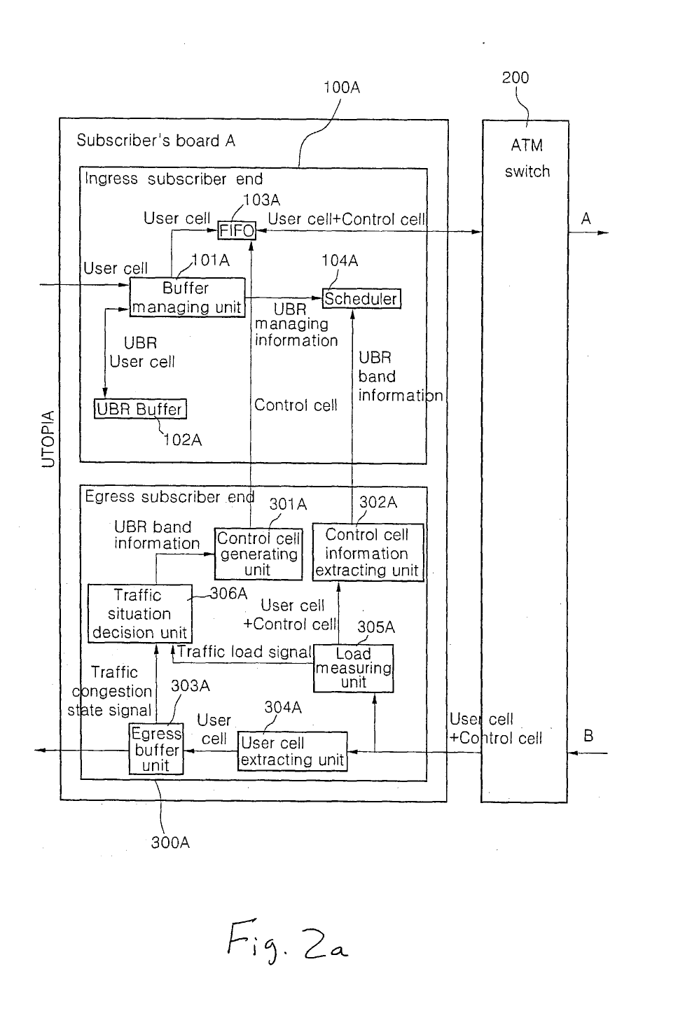

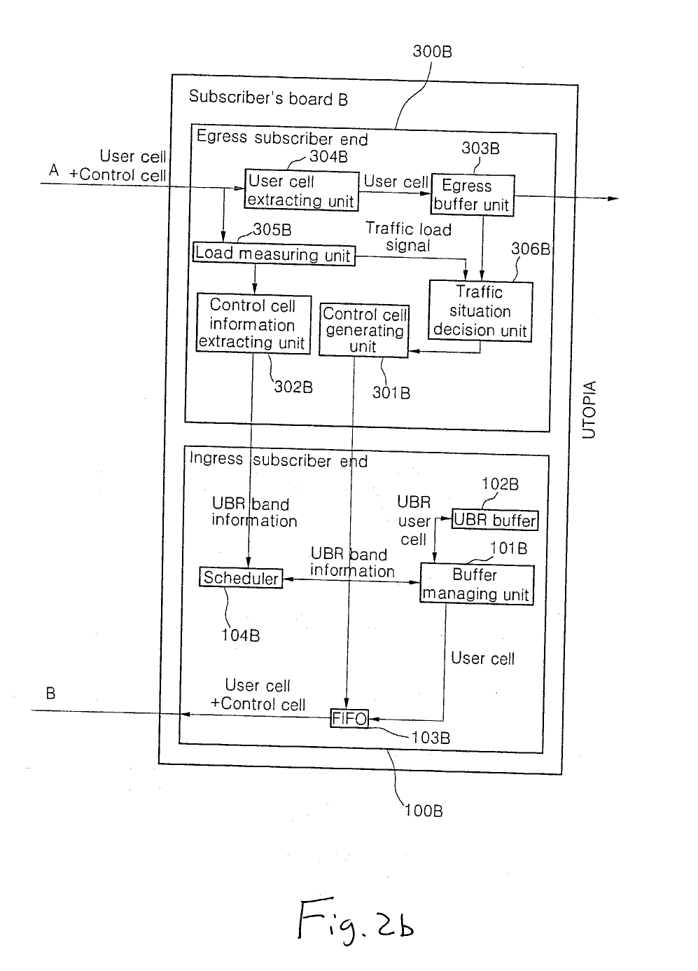

FIGS. 2a and 2b are schematic block diagrams of a traffic control apparatus for an unspecified bit rate (UBR) service in an asynchronous transfer mode (ATM) exchange in accordance with a preferred embodiment of the present invention. This apparatus includes ingress subscriber ends 100A and 100B, an ATM switch 200, and egress subscriber ends 300A and 300B. The ingress subscriber ends 100A and 100B and the egress subscriber ends 300A and 300B determine UBR bands through a periodic check of cell traffic transmitted from the ATM switch 200. The ingress and egress subscriber ends also process UBR user cells according to the UBR band.

For example, a traffic situation decision unit 306A in egress subscriber end 300A of a subscriber's board A determines the UBR band in accordance with the presence of cell traffic congestion or a traffic loading state transmitted from the ATM switch 200. The traffic situation decision unit 306A loads the determined UBR band onto a reverse control cell through a control cell generating unit 301A, and transmits the UBR band to the FIFO 103A of the ingress subscriber 100A in the same-side subscriber's board A.

A FIFO 103A transmits the reverse control cell transmitted from the control cell generating unit 301A, together with user cells input from a physical layer to the ingress subscriber end 100A, to the egress subscriber end 300B of the other side subscriber's board B through the ATM switch 200. A control cell information extracting unit 302B in the egress subscriber end 300B of the subscriber's board B then extracts the information on the UBR band of the egress subscriber end 300A in the subscriber's board A from the control cell that is input through the ATM switch 200, and transmits the UBR band information to a scheduler 104B of the ingress subscriber end 100B of the subscriber' board B.

Subsequently, the scheduler 104B determines extract time of the UBR user cell based on the UBR band information transmitted from the control cell information extracting unit 302B, and lets the UBR user cells be processed through a buffer managing unit 101B. In other words, in case that the UBR band is decreased, the UBR user cell corresponding to the decreased UBR band is provisionally stored in the buffer, and is either output or discarded depending on the buffer threshold. In contrast, if the UBR band is increased, the UBR user cell corresponding to the increased UBR band is transmitted to the ATM switch 200. In the meantime, details on how to process the UBR user cell in the ingress subscriber end 100A of the subscriber's board A in accordance with the UBR band information determined by the egress subscriber end 300B of the subscriber's board B will not be decided at this point since they are almost same as explained before.

A configuration of the traffic control apparatus for UBR service in an ATM exchange will now be explained in greater detail, mainly focusing on the subscriber's board A. First of all, the subscriber's board A includes the ingress subscriber end 100A and the egress subscriber end 300A. The ingress subscriber end 100A includes a buffer managing unit 101A, a UBR buffer 102A, a FIFO 103a, and a scheduler 104A. The egress subscriber end 300A includes a control cell generation unit 301A, a control cell information extracting unit 302A, an egress buffer unit 303A, a user cell extracting unit 304A, a load measuring unit 305A, and a traffic situation decision unit 306A.

The buffer managing unit 101A in the ingress subscriber end transmits the user cell transmitted from the UTOPIA to the ATM switch 200 according to priorities which correspond to each quality of service. More specifically, traffic such as constant bit rate (CBR) and variable bit rate (VBR) which require a real-time process have top priorities, and non-real time traffic like the available bit rate (ABR) and the unspecified bit rate (UBR) have low priorities. Preferably, the user cell is transmitted to the ATM switch 200 in order of CBR, VBR, ABR, and UBR. At this time, if the transmitted user cell happens to be the UBR user cell, the buffer managing unit 101A transmits the UBR user cell to the UBR buffer 102A.

The buffer managing unit 101A will extract the UBR user cell from the UBR buffer 102A at an appropriate time using UBR managing information of the scheduler 104A, and then will transmit the UBR user cell to the ATM switch 200.

The UBR buffer 102A, under control of the buffer managing unit 101A, stores the UBR user cell by connections.

The FIFO 103A transmits the user cell transmitted from the buffer managing unit 101A and the reverse control cell transmitted from the control cell generating unit 301A of the egress subscriber end 300A to the ATM switch 200 according to the priorities.

The scheduler 104A receives information on the UBR band of the egress subscriber end 300A in the other side subscriber's board B from the control cell information extracting unit 302A of the egress subscriber end 300A, and based on the UBR band information, determines the extract time of the UBR user cell at the UBR buffer 102A. Then, the scheduler 104A transmits the UBR managing information including the determined extract time of the UBR user cell to the buffer managing unit 101A.

The control cell generating unit 301A in the egress subscriber end loads the UBR band information transmitted from the traffic situation decision unit 306A onto the reverse control cell and transmits the UBR band information to the FIFO 103A.

The control cell information extracting unit 302A extracts the UBR band information from the control cell transmitted from the ATM switch 200, and transmits the extracted UBR band information to the scheduler 104A.

The egress buffer unit 303A includes a plurality of buffers (such as, CBR buffer, VBR buffer, ABR buffer, and UBR buffer) before transmitting the user cells to the UTOPIA, provisionally stores the cells in a corresponding buffer by classes, extracts the user cells according to priorities, and finally transmits them to the UTOPIA. In addition, the egress buffer unit 303A designates a threshold for the UBR buffer therein, and decides whether or not the UBR user cell stored in the UBR buffer exceeds the threshold of the buffer.

Depending on the decision made on whether or not the UBR user cell exceeds the threshold of the buffer, the egress buffer unit 303A periodically transmits a traffic congestion state signal corresponding to the decision to the traffic situation decision unit 306A. That is to say, the UBR buffer in the egress buffer 303A has the lowest priority. If a traffic having the maximum speed of 155 Mbps flows from the ATM switch 200 while traffic congestion is present, the egress subscriber end 300A transmits the traffic to the UTOPIA at the maximum speed of 149 Mbps. This means that the user cells that are not transmitted to the UTOPIA at the time of cell traffic congestion are saved in the egress buffer unit 303A. Here, since the UBR user cell is stored in the UBR buffer having the lowest priority, the egress buffer unit 303A, supposing that the cell traffic is in a normal state, investigates a maximum storage capacity of the UBR user cells in the UBR buffer, and designates the maximum value as the threshold of the UBR buffer.

Afterwards, the egress buffer unit 303A, depending on whether the UBR user cell stored in the UBR buffer exceeds the threshold, periodically transmits a corresponding traffic congestion state signal to the traffic situation decision unit 306A. If the UBR user cell stored in the UBR buffer is greater than the threshold of the UBR buffer, the egress buffer unit 303A transmits the traffic congestion generating signal to the traffic situation decision unit 306A, but if not, it transmits a normal state signal to the traffic situation decision unit 306A.

The user cell extracting unit 304A extracts the user cell from the cell information transmitted from the ATM switch, and transmits the user cell to the egress buffer unit 303A.

The load measuring unit 305A includes a counter using a shift register. And, the load measuring unit 305A measures the traffic load per cell time through the user cell and the control cell input into the egress subscriber end 300A from the ATM switch 200, and transmits the corresponding traffic load signal to the traffic situation decision unit 306A. In other words, if cells are input into the egress subscriber end 300A for one cell time, the load measuring unit 305A sets ‘1’ for the shift register composing the counter. If cells are not input into the egress subscriber end 300A, the load measuring unit sets ‘0’. Then, the load measuring unit 305A shifts one space at the next cell time after the setting, and repeats the setting procedure, such as, ‘1’ or ‘0’, according to the cell flow.

This may be illustrated as follows. Suppose that the counter is composed of 128 shift registers. Then, the load measuring unit 305A counts ‘1’ set for each register in those 128 cell intervals, and measures cell traffic amount input into the egress subscriber end 300A from the ATM switch 200.

Next, if the cell count value of the counter at a specific cycle is 120, the maximum speed of the cell traffic that can be input into the egress subscriber end 300A from the ATM switch 200 becomes 155 Mbps, and the traffic speed will be (155 Mbps * 120 cells)/128=145 Mbps.

The load measuring unit 305A transmits the traffic speed information (i.e., 145 Mbps) to the traffic situation decision unit 306A.

The traffic situation decision unit 306A determines the UBR band in accordance with the traffic congestion state signal transmitted from the egress buffer unit 303A and the traffic load signal transmitted from the load measuring unit 305A. Decision unit 306A then transmits the determined UBR band information to the control cell generating unit 301A. That is, the traffic situation decision unit receives the traffic load signal and the traffic congestion state signal that are periodically output from the load measuring unit 305A and the egress buffer unit 303A, and then decides the cell traffic situation input into the egress subscriber end 300A from the ATM switch 200. The traffic situation decision unit 306A will now be explained in greater detail.

First, the traffic situation decision unit 306A decides whether the traffic congestion state signal transmitted from the egress buffer unit 303A is a genuine state signal notifying the presence of the traffic congestion. If not, that is, if the traffic congestion state signal is not the state signal for the presence of the traffic congestion, the traffic situation decision unit 306A confirms the traffic load signal transmitted from the load measuring unit 305A, and decides whether the traffic load measured by the load measuring unit 305A is below the load standard value.

If the traffic load is below the load standard value, the traffic state situation unit 306A increases the current UBR band, and lets the ingress subscriber end 100B of the other side subscriber's board B process the UBR user cell in accordance with the increased UBR band information. More specifically, the traffic situation decision unit 306A finds out that if the traffic load measured by the load measuring unit 305A is below the load standard value® * c), there is an available band that is not occupied by the current real time traffic, so it decides to increase the UBR band using Equation 2 as follows:

Current UBR band+{(r*c−Current UBR band)/constant} (2)

where, ‘r’ is target link utilization and ‘c’ is link capacity.

Later, the traffic situation decision unit 306A inserts the increased UBR band information to the reverse control cell through the control cell generating unit 301A, in order to let the UBR user cell be processed in the ingress subscriber end 100B of the other side subscriber's board B according to the increased UBR band information. Further, the traffic situation decision unit 306A feedbacks the reverse control cell into the ingress subscriber end 100B in the other side subscriber's board B through the ingress subscriber end 100A in the self side subscriber's board A and through the ATM switch 200.

In such case, the scheduler 104B in the ingress subscriber end 100B of the other side subscriber's board B extracts the UBR band information from the reverse control cell, and processes the UBR user cell according to the extracted UBR band information. In other words, scheduler 104B in the ingress subscriber end of the other side subscriber's board B determines the extract time for the UBR user cell from the UBR buffer in accordance with the UBR band information of the egress subscriber end 300A in the feedbacked subscriber's board A. Then, the scheduler 104B transmits the UBR managing information including the determined extract time to the buffer managing unit 101B.

The buffer managing unit 101B processes the UBR user cell according to the UBR managing information transmitted from the scheduler 104B. That is, the buffer managing unit 101B extracts the UBR user cell corresponding to the increased UBR band from the UBR buffer 102B, and transmits the UBR user cell to the ATM switch 200.

In this manner, any available band in the real-time traffic which not being used can be utilized for the UBR traffic, and the UBR traffic, output from the ingress subscriber end 100B to the egress subscriber end 300A through the ATM switch 200, can be controlled.

If the traffic load measured by the load measuring unit 305A is greater than the load standard value, that is, the cell traffic input into the egress subscriber end 300A from the ATM switch 200 is not in the cell traffic congestion state and in a traffic transmission speed with appropriate load level, the traffic situation decision unit 306A remains the current UBR band as is.

After that, the traffic situation decision unit 306A feedbacks the maintained UBR band information to the ingress subscriber end 100B in the other side subscriber's board B, and lets the ingress subscriber end 100 process the UBR user cell in accordance with the aforementioned UBR band information. Then, the traffic situation decision unit 306A determines the UBR band by comparing the decreased UBR band with the UBR available band (DBW) of the UBR connection.

By decreasing the current UBR band to half (0.5 times) and comparing the decreased UBR band with the UBR available band DBW), if the decreased UBR band is less than the UBR available band (DBW), the UBR available band (DBW) is designated as the UBR band. On the other hand, if the decreased UBR band is greater than the UBR available band (DBW), the decreased UBR band is designated as the UBR band.

Once the UBR band information is determined, it is fedback to the ingress subscriber end 100B in the other side subscriber's board B. In such case, the ingress subscriber end 100B in the other side subscriber's board B, based on the fedback UBR band information, processes the UBR user cell that is output to the egress subscriber end 300A in the subscriber's board A. That is, the ingress subscriber end 100B of the other side subscriber's board stores the corresponding UBR cell to the decreased UBR band in the UBR buffer 102B, or discards the UBR cell. This, in turn, increases a real-time traffic band, thereby guaranteeing the quality of service of the real time traffic.

To summarize the UBR traffic control method described above, first of all, the egress subscriber 300A of the subscriber's board A makes the decision on the UBR traffic situation transmitted from the ingress subscriber end 100B of the other side subscriber's board B through the ATM switch 200, and generates the UBR band information based on the decision. Then, it feedbacks the UBR band information to the ingress subscriber end 100B via the ATM switch 200 and the egress subscriber end 300B of the other side subscriber's board B, and controls the UBR traffic output from the ingress subscriber end 100B to the egress subscriber end 300A in accordance with the fedback UBR band information.

In the meantime, the same method may be also applied to control the UBR traffic output from the ingress subscriber end 100A of the subscriber's board A to the egress subscriber end 300B of the other side subscriber's board B. That is, the egress subscriber end 300B makes the decision on the UBR traffic situation, and generates the UBR band information based on the decision. Then, it feedbacks the generated UBR band information to the ingress subscriber end via the ATM switch 200 and the egress subscriber end 300A, and controls the UBR traffic outputted from the ingress subscriber end 100A to the egress subscriber end 300B in accordance with the fed back UBR band information. Here, the ingress subscriber end 100B and the egress subscriber end 300B in the subscriber's board B may have the same configuration with those of the subscriber's board A.

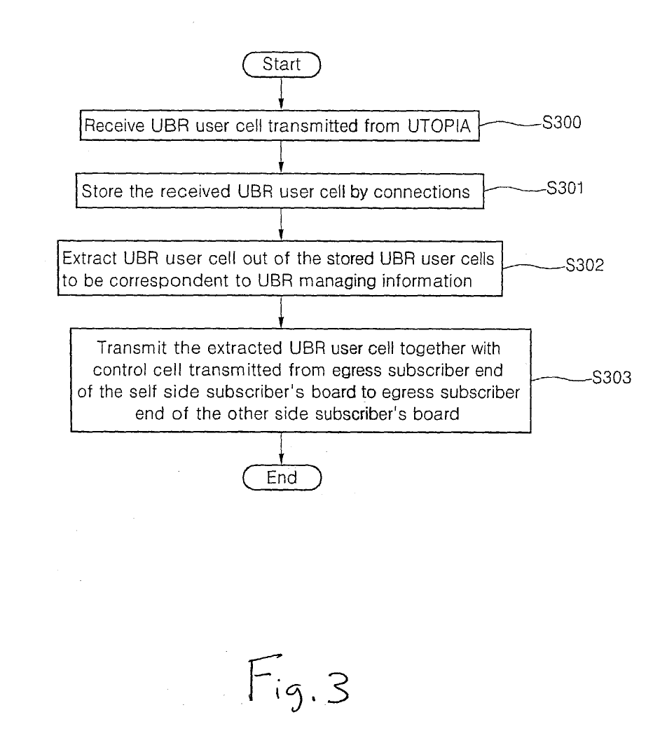

FIG. 3 is a flow chart illustrating a UBR traffic control method of an ingress subscriber end in accordance with a preferred embodiment of the present invention. As depicted, the ingress subscriber end receives the UBR user cell transmitted from the UTOPIA (S300) and stores the received UBR user cell by connections (S301).

On completion of step 301, the ingress subscriber end extracts the UBR user cell out of the stored UBR user cells, to be correspondent to UBR managing information (S302).

The UBR managing information may be the extract time of the determined UBR user cell using the UBR band information transmitted from the egress subscriber end of the self side subscriber's board. Therefore, the ingress subscriber end, based on the determined extract time, extracts the UBR user cell out of the stored UBR user cells.

Next, the ingress subscriber end transmits the extracted UBR user cell together with a control cell transmitted from the egress subscriber end of the self side subscriber's board to the egress subscriber end of the other side subscriber's board (S303). Here, the control cell includes the UBR band information. Then, using the UBR user cell and the control cell transmitted from the ingress subscriber, the egress subscriber end of the other side subscriber's board controls the UBR traffic as follows.

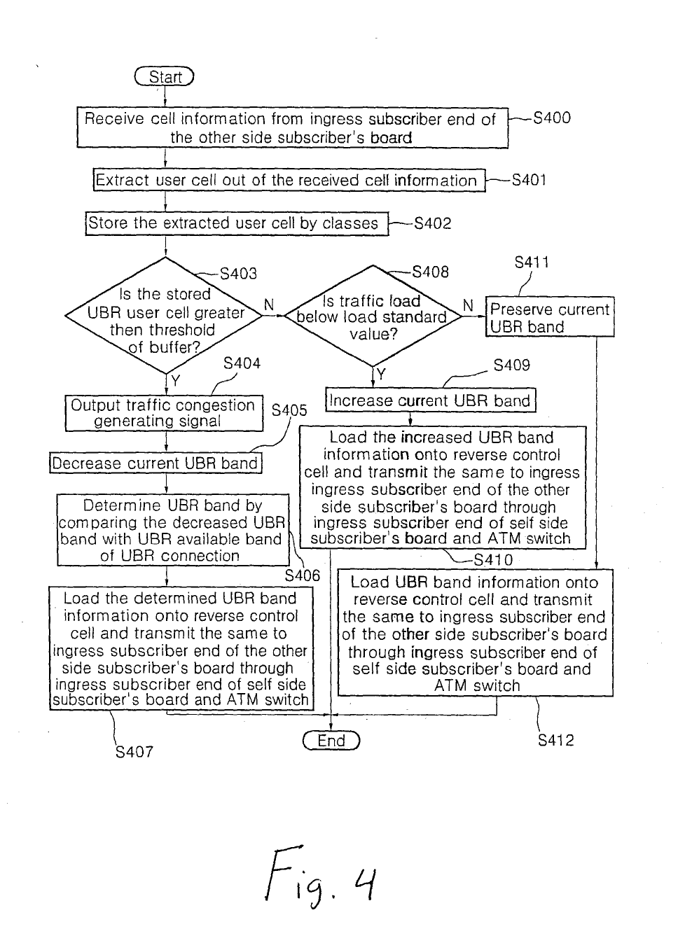

FIG. 4 is a flow chart showing how to control UBR traffic at the egress subscriber end in accordance with a preferred embodiment of the present invention. In an initial step, once cell information including the user cell and the control cell is received from the ingress subscriber end of the other side subscriber's board (S400), the egress subscriber end extracts a user cell out of the received cell information (S401). Next, the egress subscriber end stores the extracted user cell into a corresponding buffer (S402). For example, a CBR user cell is stored in the CBR buffer, and a VBR user cell in the VBR buffer, and a UBR user cell in the UBR buffer. An illustrative case of where the UBR user cell is stored in the UBR buffer will now be provided.

First, the egress subscriber end decides whether or not the stored UBR user cell exceeds the threshold of the UBR buffer (S403). In result of step 403, if it turns out that the UBR user cell is greater than the threshold of the UBR buffer, the egress subscriber outputs the traffic congestion generating signal (S404).

Following step 404, the egress subscriber end decreases the current UBR band (S405), and determines the UBR band by comparing the decreased UBR band with the UBR available band of the UBR connection (S406). More specifically, if the decreased UBR band is below the UBR available band, the egress subscriber end determines the UBR available band as the UBR band. However, if the decreased UBR band exceeds the UBR available band, the egress subscriber end determines the decreased UBR band as the UBR band.

After step 406, the egress subscriber end loads the determined UBR band information onto the reverse control cell, and transmits the UBR band information to the ingress subscriber end of the other side subscriber's board through the ingress subscriber end of the self side subscriber's board and the ATM switch (S407). The ingress subscriber end of the other side subscriber's board processes the UBR user cell in accordance with the determined UBR band information.

Next, the ingress subscriber end of the other side subscriber's board processes the UBR user cell in accordance with the transmitted band information. As the result of the decision made in step 403, if the UBR user cell is not larger than the threshold of the UBR buffer, the egress subscriber end decides whether or not the traffic load of the UBR user cell is below the standard value (S408).

In step 408, if it turns out that the traffic load of the UBR user cell is below the standard value, the egress subscriber end increases the current UBR band (S409). At this time, Equation 2 may be used for increasing the UBR band.

When step 409 is completed, the egress subscriber end loads the increased UBR band information onto the reverse control cell, and transmits the increased UBR band information to the ingress subscriber end of the other side subscriber's board through the ingress subscriber end of the self side subscriber's board and the ATM switch (S410). The ingress subscriber end of the other side subscriber's board processes the UBR user cell in accordance with the increased UBR band information.

Next, the ingress subscriber end of the other side subscriber's board processes the UBR user cell in accordance with the transmitted band information. In case the result of the decision made in step 408 indicates that the traffic load of the UBR user cell is not below the standard value, the current UBR band is kept (S411).

Following this, the egress subscriber end loads the maintained UBR band information onto the reverse control cell, and transmits the UBR band information to the ingress subscriber end of the other side subscriber's board through the ingress subscriber end of the self side subscriber's board and the ATM switch (S412). Then, the ingress subscriber end of the other side subscriber's board processes the UBR user cell in accordance with the transmitted band information.

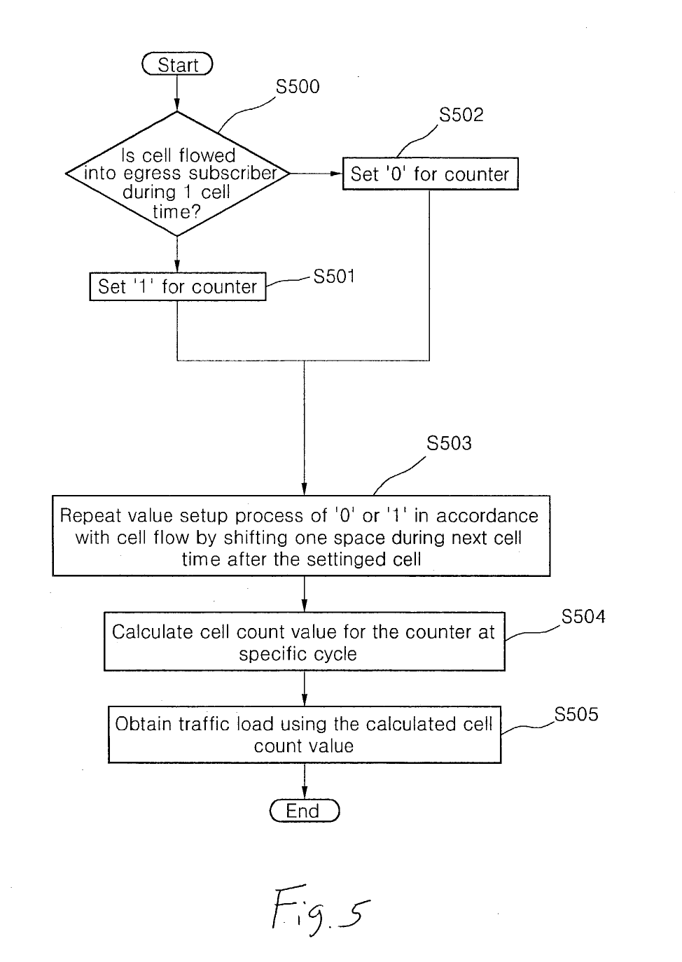

FIG. 5 is a flow chart showing how to measure traffic load of the UBR user cell in accordance with a preferred method of the present invention. First, it is decided whether a cell has been input into the egress subscriber end for 1 cell time (S500). If it turns out that a cell has been into this end for this time, the counter sets ‘1’ (S501), and if not (that is, if there is no cell has flowed into this end for 1 cell time), the counter sets ‘0’ instead (S502).

Once the cell is set as described above, in a next cell time, the same procedure of setting ‘0’ or ‘1’, depending on whether a cell has been input or not, is repeated by shifting one space (S503).

Following step 503, a cell count value of the counter at a specific cycle is calculated (S504). Using this calculated cell count value, the traffic load is obtained (S505). For instance, suppose that the counter is composed of 128 shift registers and the cell counter value of the counter at a specific cycle is 120, and the maximum speed of the cell traffic is 155 Mbps, then the traffic load will be (155 Mbps * 120 cells)/128=145 Mbps. The thusly calculated traffic load is then transmitted to the traffic situation decision unit.

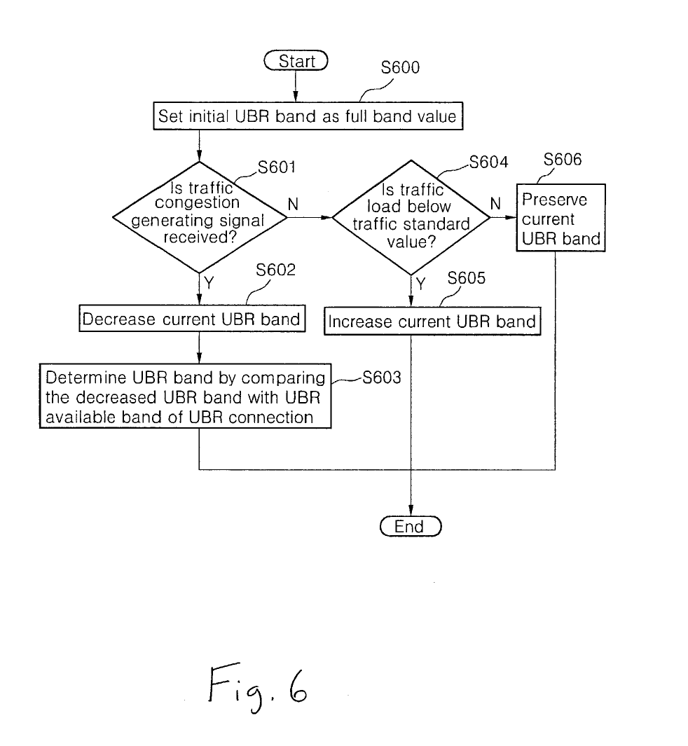

FIG. 6 is a flow chart showing how to determine the UBR band in accordance with a preferred embodiment of the present invention. In a first step, the initial UBR band is set as a full band value (S600). Then, it is decided whether or not a traffic congestion generating signal is received (S601). If a traffic congestion generating signal is received, the current UBR band is decreased (S602), and is compared with the UBR available band of the UBR connection to determine the UBR band (S603).

Similar to before, here again, if the decreased UBR band is below the UBR available band, the egress subscriber end determines the UBR available band as the UBR band, while if the decreased UBR band exceeds the UBR available band, the decreased UBR band is determined as the UBR band.

If in any case the traffic congestion generating signal is not received in step 601, it is decided whether the traffic load is below the standard value (S604). If it turns out that the traffic load is below the standard value, the current UBR band is increased (S605). However, if the traffic load is not below the standard value, the current UBR band is maintained (S606).

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A traffic control apparatus for unspecified bit rate (UBR) service in an asynchronous transfer mode (ATM) exchange, comprising:
an egress subscriber end which extracts UBR band information from a first subscriber board, and which determines a UBR band in accordance with a presence of cell traffic congestion and a state of traffic loading transmitted from the first subscriber board; and
an ingress subscriber end which receives the UBR band information determined by the egress subscriber end, feeds back the UBR band information to the first subscriber board, and processes a UBR user cell in accordance with the UBR band information of the first subscriber board extracted from the egress subscriber end.

2. The apparatus of claim 1, wherein the egress subscriber end comprises:
a load measuring unit which measures traffic load of a transmitted cell from an ATM switch and which outputs a traffic load signal;
a user cell extracting unit which extracts a user cell among cells output from the ATM switch;
an egress buffer unit which outputs a traffic congestion state signal based on a decision that is periodically made based on traffic situations of a UBR user cell stored in an internal UBR buffer among user cells extracted by the user cell extracting unit;
a traffic situation decision unit which decides a UBR band corresponding to the traffic congestion state signal output from the egress buffer and the traffic load signal output from the load measuring unit, and which outputs information on the determined UBR band;
a control cell generating unit which loads the information on the UBR band output from the traffic situation decision unit onto a control cell, and which transmits the information to an ingress subscriber end inside of a second subscriber board; and
a control cell information extracting unit which extracts the information on the UBR band of the first subscriber board from the control cell that is transmitted from the load measuring unit, and which transmits the information to the ingress subscriber end inside of the second subscriber board.

3. The apparatus of claim 1, wherein the ingress subscriber end comprises:
a buffer managing unit which processes user cells transmitted from an universal test and operation physical interface for ATM (UTOPIA) in accordance with priority;
a UBR buffer which stores UBR user cells among other user cells input in the buffer managing unit;
a first-in first-out (FIFO) which extracts the information on the UBR band from the control cell transmitted from the control cell generating unit of the egress subscriber end, and which transmits the information together with the user cell to an ATM switch; and
a scheduler for deciding an extract time of the UBR user cell in accordance with the information on the UBR band of the first subscriber board transmitted from the control cell information extracting unit of the egress subscriber end, and transmitting an UBR managing information including the decided extract time to the buffer managing unit.

4. The apparatus of claim 3, wherein the UBR buffer stores the inputted UBR user cell by connections.

5. A traffic control method of unspecified bit rate (UBR) service in an asynchronous transfer mode (ATM) exchange, comprising:
receiving cell information from an ingress subscriber end of a first subscriber board;
extracting a UBR user cell out of the received cell information and storing the UBR user cell in a buffer;
determining a UBR band based on a decision on whether the stored UBR user cells exceed a threshold of the buffer; and
extracting a UBR user cell out of the user cells transmitted from a universal test and operation physical interface for ATM (UTOPIA), and transmitting the extracted UBR user cell together with the determined UBR band information to the first subscriber board.

6. A traffic control method for unspecified bit rate (UBR) service in an asynchronous transfer mode (ATM) exchange, comprising:
receiving cell information from an ingress subscriber end of a first subscriber board;
extracting a UBR user cell out of the received cell information and storing the UBR user cell in a buffer;
deciding whether or not the stored UBR user cells exceed a threshold of the buffer;
decreasing a current UBR band, if the UBR user cell exceeds a threshold of a corresponding buffer;
determining a UBR band by comparing the decreasing UBR band with a UBR available band; and
transmitting the determined UBR band information to the first subscriber board through an ingress subscriber end of a second subscriber board and an ATM exchange.

7. The method of claim 6, wherein the cell information includes at least one of user cells or control cells.

8. The method of claim 6, wherein the threshold of the buffer is a maximum storage value of the UBR user cell in a UBR buffer, when the cell traffic is in a normal state.

9. The method of claim 6, further comprising:
deciding whether a traffic load is below a predetermined load standard value, when the UBR user cells does not exceed the threshold of a corresponding buffer, increasing a current UBR band, if the traffic load is below the predetermined load standard value; and
transmitting the increased UBR band information to the egress subscriber end of the first subscriber board through the ingress subscriber end of the second subscriber board and an ATM switch.

10. The method of claim 9, wherein the load standard value is obtained through a calculation of target link utilization and link capacity.

11. The method of claim 9, further comprising:
maintaining the current UBR band if the traffic load is not below the predetermined load standard value,

12. The method of claim 9, wherein increasing the current UBR band is obtained based on the following equation: Current UBR band+{(Load standard value−Current UBR band)/Constant}.

13. The method of claim 6, wherein the step of determining the UBR band based on the comparison of the decreased UBR band with a UBR available band is accomplished in accordance with steps that include:
determining the UBR available band as the UBR band if the decreased UBR band is below the UBR available band; and
determining the decreased UBR band as the UBR band if the decreased UBR band exceeds the UBR available band.

14. A traffic control method of unspecified bit rate (UBR) service in an asynchronous transfer mode (ATM) exchange mounted with an ATM switch for processing a user cell, comprising:
receiving user cells from a UTOPIA and storing the cells by connections;
extracting a UBR user cell corresponding to an UBR managing information out of the stored user cells; and
transmitting the extracted UBR user cell together with a control cell transmitted from an egress subscriber end of one subscriber board to an egress subscriber end of another subscriber board.

15. The method of claim 14, wherein the UBR managing information is an extract time of the determined UBR user cell using the UBR band information transmitted from the egress subscriber end of said one subscriber board.

16. The method of claim 14, wherein the control cell includes the determined UBR band information corresponding to a traffic congestion state signal or a traffic load signal from the egress subscriber end of said one subscriber board.

17. A traffic control method for UBR service in an ATM exchange to measure traffic load at a load measuring unit of an egress subscriber end, comprising:
(a) setting a value for a counter to be correspondent to presence of cell flow during a first cell time, and shifting the counter by one space during a second cell time, and repeating the value setup process for the counter corresponding to the presence of cell flow;
(b) calculating a cell count value of the counter in a specific cycle; and
(c) obtaining a load using the calculated count value.

18. The method of claim 17, wherein step (a) includes:
deciding whether or not a cell flows into the egress subscriber end during the first cell time;
setting a first value for the counter if the cell is flowed into the egress subscriber end, and setting a second value for the counter if the cell has not flowed into the egress subscriber end; and
repeating the value setup process for the counter corresponding to the presence of the cell flow after shifting the counter by one space during the second cell time.

19. The method of claim 17, wherein the steps of obtaining the load based on the calculated count value accomplished by a calculation of a maximum speed of cell traffic, the calculated count value, and the counter register.

20. A traffic control method of unspecified bit rate (UBR) service in an asynchronous transfer mode (ATM) exchange to determine a UBR band at a traffic situation unit, comprising:
setting an initial UBR band as a full band value;
deciding whether a traffic congestion generating signal is received;
decreasing a current UBR band if the traffic congestion generating signal is received; and
determining a UBR band by comparing the decreased UBR band with a UBR available band.

21. The method of claim 20, further comprising:
deciding whether a traffic load is below a load standard value if the traffic congestion generating signal is received; and
increasing a current UBR band if the traffic load is below the load standard value.

22. The method of claim 21, further comprising the step of maintaining the current UBR band if the traffic load is not below the load standard value.
